(19) United States
(12) Patent Application Publication
(10) Pub. No.: US 2011/0278133 A1
(43) Pub. Date: Nov. 17, 2011

(54) GAPLESS MAIN SHAFT LOCKING APPARATUS

(75) Inventor: Ting-Kuang Chen, Keelung (TW)

(73) Assignee: TOP GEARBOX INDUSTRY CO., LTD, Taoyuan County (TW)

(21) Appl. No.: 12/778,469

(22) Filed: May 12, 2010

(51) Int. Cl. B25F 5/00; F16D 67/00

(52) U.S. Cl. 192/223

(57) ABSTRACT

A gapless main shaft locking apparatus includes a fastening ring, an elastic retaining device, a plurality of detent pins, a driving plate and an output shaft. The elastic retaining device is installed in the fastening ring and has an inner space in which elastic portions and cylinder portions are disposed. Each of the detent pins is disposed between one of the elastic portions and one of the cylinder portions. The driving plate has a central hole, and the periphery of the central hole includes fan-shaped convex portions. A side of the driving plate has a plurality of concave slots for receiving the elastic retaining device. The output shaft includes a polygonal shaft having a regular polygonal cross section. The polygonal shaft passes through the central hole of the driving plate, and each side of the polygonal shaft is contacted with one of the detent pins.

### BACKGROUND OF THE INVENTION

1. Field of the Invention

The present invention relates generally to a main shaft locking apparatus applicable for a power tool, according to which when the power tool is not provided with power supply, a main shaft of the power tool is prevented from being rotated by any external force and does not generate any noise.

2. The Prior Arts

A conventional power tools, e.g., a power drill, is typically driven by electric power, and can be classified into corded, cordless (chargeable) or a combination of both. Generally, the power tool not only can hold a drilling bit for drilling a hole, but also can hold a screwdriver bit to screw or unscrew a screw. Usually, the corded power tool is more powerful than the cordless power tool and is more suitable for heavy duty. However, when the power tool is used in places without any socket, the cordless power tool driven by a chargeable battery is the only option. Unfortunately, when the battery is running low and is unable to recharge, the cordless power tool is unable to operate. Similarly, a sudden power failure may instantly disable the corded power tool. When the power is not supplied normally, the power tool can be temporarily operated as a manual tool. For example, the power tool is used as a regular manual screwdriver.

A conventional power tool usually includes a motor having a driving shaft, a driving gear coupled with the driving shaft of the motor, a gear set engaged with the driving gear, a follower gear engaged with the gear set and a central shaft coupled with the follower gear. In such a way, when the power tool is temporarily operated as a manual screwdriver, the follower gear alternatively serves as a temporary driving gear. The torque generated thereby is transmitted by the gear set to the original driving gear which is coupled to the driving shaft of the motor. As such, the screwdriver bit runs idly, and the power tool cannot be used as a manual screwdriver.

Taiwan Patent Nos. 410,714 and 334,869 have proposed main shaft locking mechanisms as a solution with respect to the foregoing problems. However, the main shaft locking mechanisms employs a fixing ring, and a main shaft and a plurality of rollers or steel balls secured in an inner hole of the fixing ring. When the power is not supplied to the power tool and an external force is applied to drive the main shaft to rotate, the main shaft drives the rollers or the steel balls to interfere against the fixing ring, thereby locking up the main shaft. However, the mechanism requires the fixing ring to be machined with a very high precision, which makes concentricity between the main shaft and the fixing ring. Otherwise, an unsatisfactory concentricity between the main shaft and the fixing ring may adversely cause the force to be non-uniformly distributed onto the rollers or the steel balls, so as to impair the locking effect.

Taiwan Patent No. M363,979 has disclosed a main shaft locking device to overcome the aforementioned disadvantages. However, no matter the main shaft is rotated clockwise or counterclockwise; the device inevitably makes noise due to gaps defined between detent members and the polygonal main shaft. A user may feel uncertain because the existence of gaps during operation.

### SUMMARY OF THE INVENTION

A primary objective of the present invention is to overcome disadvantages of conventional main shaft locking mechanism of a power tool, in which no matter the main shaft is rotated clockwise or counterclockwise, gaps defined between a fastening ring, detent pins and sides of the polygonal main shaft generate noise during operation and a user may feel uncertain.

One of characteristics of the present invention is that a main shaft locking apparatus having a plurality of detent pins is provided with an elastic retaining device having elastic portions. The detent pins are disposed in the elastic retaining device, and an output shaft passes through the elastic retaining device. The elastic portions of the elastic retaining device act on the detent pins, thereby eliminating gaps between a fastening ring and the output shaft. Therefore, no matter a power system drives the output shaft to rotate clockwise or counterclockwise or the output shaft actively rotates clockwise or counterclockwise, no noise is made due to the aforementioned gaps.

In order to achieve the objectives, a gapless main shaft locking apparatus according to the present invention includes a fastening ring, an elastic retaining device, a plurality of detent pins, a driving plate and an output shaft. The elastic retaining device has an inner space in which elastic portions and cylinder portions are disposed with a manner of being respectively arranged as a pair and aligned at correspondingly symmetrical positions along an axial direction of the inner space. The elastic retaining device is installed in the fastening ring. The detent pins are installed in the inner space of the elastic retaining device and each of the detent pins is respectively disposed between one of the elastic portions and one of the cylinder portions. The driving plate is connected to a power system and provided with a central hole. The periphery of the central hole includes a plurality of fan-shaped convex portions. A side surface of the driving plate has a plurality of concave slots circularly arranged for receiving the elastic retaining device. The output shaft is a polygonal shaft having a cross section in a regular polygonal shape. The polygonal shaft passes through the central hole of the driving plate, and each side of the polygonal shaft is respectively in contact with one of the detent pins. No matter the output shaft is rotated clockwise or counterclockwise, part of the detent pins can be immediately locked in the fastening ring through actions of the elastic portions, so the output shaft is unable to be rotated, and no noise is generated with the existence of gaps.

Compared to conventional mechanical designs, the present invention has advantages that the locking effect of the main shaft is not influenced by unsatisfactory concentricity, no noise is generated during operation and the user feels more certain to the operation.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partial exploded view illustrating a main shaft locking apparatus according to the present invention;

FIG. 2 is an exploded view further illustrating the main shaft locking apparatus of FIG. 1 having a fastening ring, an elastic retaining device and detent pins;

FIG. 3 is an exploded view illustrating a half of the elastic retaining device and one of the detent pin of FIG. 2;

FIG. 4 is a perspective view illustrating the fastening ring, the elastic retaining device and the detent pins being installed inside a housing and a driving plate;

FIG. 5 is a perspective view showing the main shaft locking apparatus according to the present invention;

FIG. 6A is a schematic cross sectional view illustrating the elastic retaining device, the detent pins, the driving plate and the output shaft when a motor drive the output shaft to rotate clockwise; and

FIG. 6B is a schematic cross sectional view illustrating the elastic retaining device, the detent pins, the driving plate and the output shaft.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

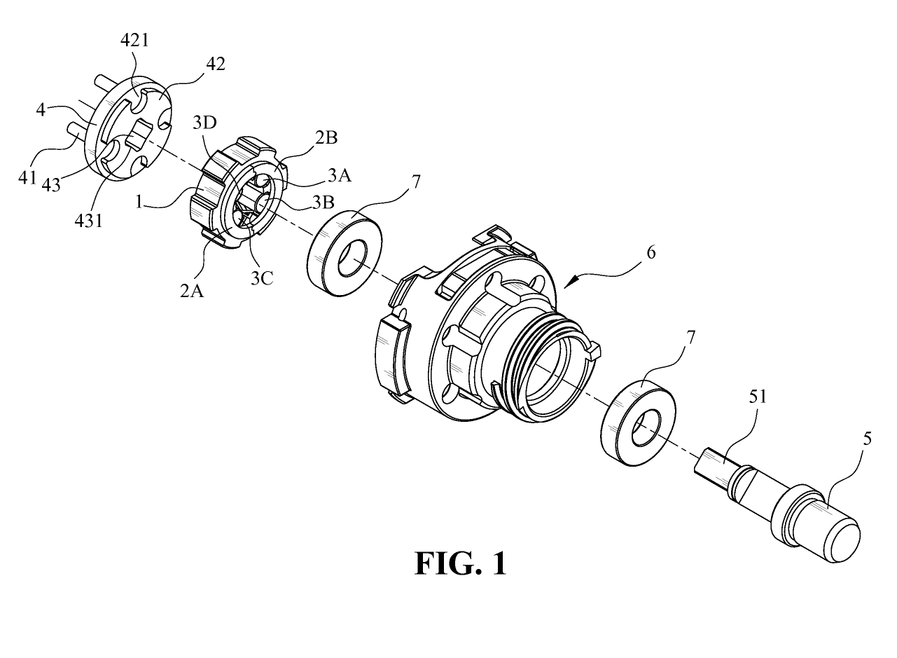

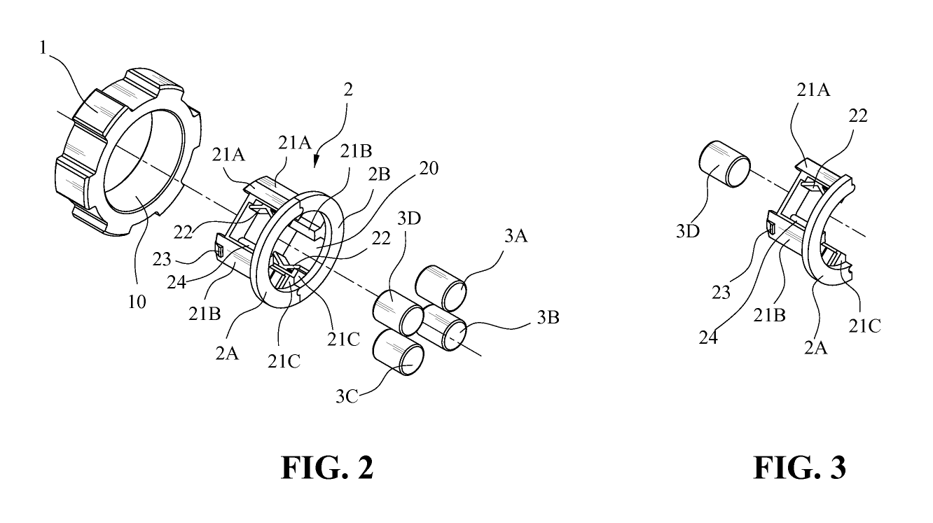

Referring to FIGS. 1 and 2, a gapless main shafting locking apparatus according to a preferred embodiment of the present invention includes a fastening ring 1, an elastic retaining device 2, a plurality of detent pins 3A-3D, a driving plate 4 and an output shaft 5. The output shaft 5 is assembled in the interior of a housing 6 of a power tool by a bearing 7, so the output shaft 5 is able to freely rotate with respect to the housing 6. A front end of the output shaft 5 is extended to the exterior of the housing 6 for being installed with a tool bit, such as a drill bit, a screwdriver bit. A polygonal shaft 51 having a regular polygon cross section is axially extended from the output shaft 5. The cross section of the polygonal shaft 51 according to the embodiment is shaped in a square.

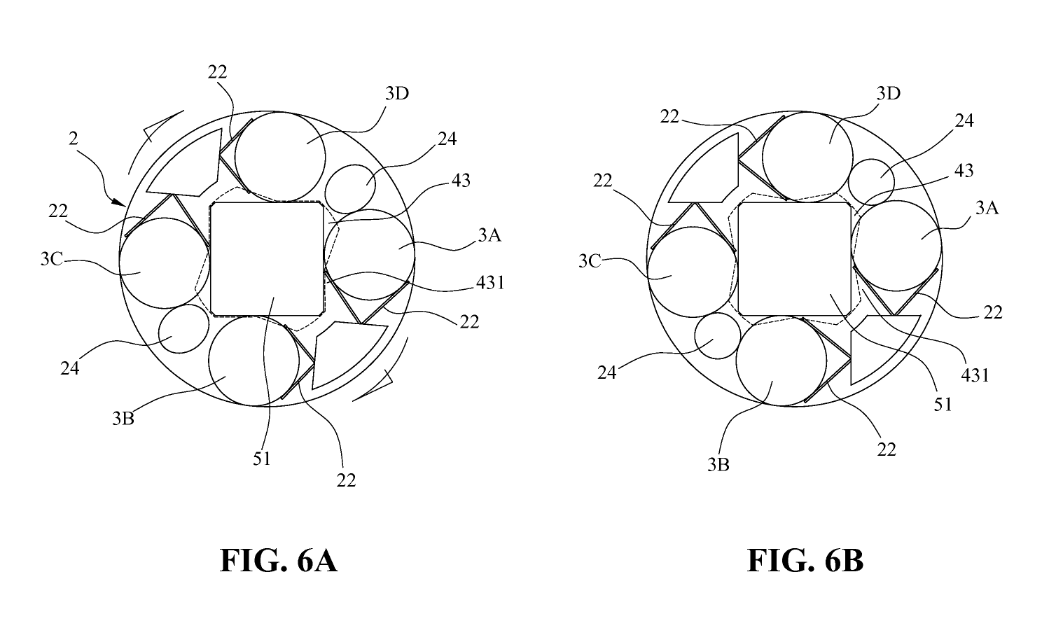

The fastening ring 1 has a through hole 10, and is installed inside the housing 6. The elastic retaining device 2 is disposed in the through hole 10 of the fastening ring 1, and the elastic retaining device 2 has an inner space 20. Elastic portions 22 and cylinder portions 24, respectively arranged as a pair and aligned at correspondingly symmetrical positions, are disposed on a side wall of the inner space 20 and along an axial direction of the inner space 20. Referring to FIGS. 2 and 3, the elastic retaining device 2 according to the embodiment includes a first main body 2A and a second main body 2B symmetric to and engaged with each other so as to form a cylindrical shape. The first main body 2A and the second main body 2B includes a first column member 21A, a second column member 21B and a third column member 21C, respectively. The elastic portions 22 are disposed at symmetrical positions of the two first column members 21A and at symmetrical positions of the two third column members 21C. The cylinder portion 24 is disposed on each of the second column members 21B. The elastic portions 22 and the cylinder portions 24 according to the embodiment are integrally formed with the first main body 2A or the second main body 2B, and made of a resilient material, such as plastic. Each of the elastic portions 22 is in a V shape. Two oblique arms of the V-shaped elastic portions 22 are deformed and spread apart when being pressed, and resumed to an original un-deformed state when not being pressed. Each of the second column members 21B includes a hook 23 on an outer surface thereof. The first main body 2A is engaged with the second main body 2B for forming the cylinder-shaped elastic retaining device 2. The elastic retaining device 2 passes through the through hole 10 of the fastening ring 1, and the hooks 23 are hooked at the periphery of the through hole 10 of the fastening ring 1, thereby connecting the fastening ring 1 with the elastic retaining device 2. Then each of the round-column shaped detent pins 3A-3D is disposed along periphery of the inner space 20 of the elastic retaining device 2, so the elastic portions 22 and the cylinder portions 24 are in contact with the detent pins. The fastening ring 1, after being installed with the elastic retaining device 2 and the detent pins 3A-3D, is mounted in the housing 6. The output shaft 5 passes through the inner space 20 of the elastic retaining device 2, and each of the detent pins 3A-3D is in contact with each side of the polygonal shaft 51 (as shown in FIG. 6B).

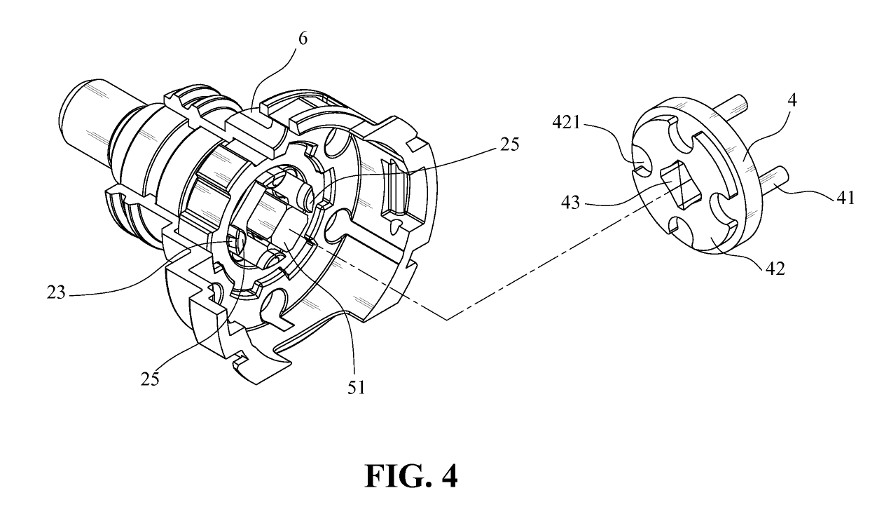

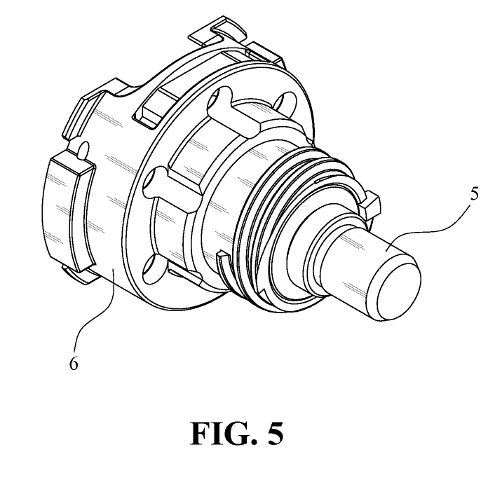

Referring to FIG. 4, the driving plate 4 is disposed inside the housing 6 and is a circular plate. One side of the driving plate 4 has a plurality of pins 41 for assembling with planetary gears (not shown) and the other side of the driving plate 4 has an elevated portion 42. The periphery of the elevated portion 42 includes a plurality of U-shaped concave slots 421. A central hole 43 is defined at a center of the driving plate 4 and the central hole 43 is a polygonal hole corresponding to the polygonal shaft 51. Each side of the central hole 43 is formed with a fan-shaped convex portion 431. After the driving plate 4 is assembled inside the housing 6, the polygonal shaft 51 passes through the central hole 43 and convex portions 25 of the elastic retaining device 2 are received in the concave slots 421. Referring to FIG. 5, the housing 6, after being assembled with the driving plate 4, is installed on a main body of the power tool (not shown), so the planetary gears (not shown) assembled with the pins 41 are engaged with a sun gear (not shown) inside the main body of the power tool, thereby forming a planetary gear set.

After the aforementioned components are assembled, when the output shaft 5 actively rotates to drive a tool bit, such as a drill bit or a screwdriver bit, a motor of the power tool drives a reduction gear set to rotate, the reduction gear set drives the planetary gear set to rotate and the planetary gear set drives the driving plate 4 to rotate. As shown in FIG. 6A, when the driving plate 4 is clockwise rotated to drive the elastic retaining device 2, the elastic portions 22 of the elastic retaining device 2 press the detent pins 3B, 3D so that the elastic portions 22 are deformed. In the mean time, the cylinder portions 24 press the detent pins 3A, 3C so that the cylinder portions 24 are deformed, thus the detent pins 3A, 3C are tightly retained between the cylinder portions 24 and the elastic portions 22. One oblique side of each fan-shaped convex portion 431 of the central hole 43 of the driving plate 4 is in contact with a polygon side of the polygonal shaft 51 due to rotation, thus the output shaft 5 is driven to rotate. The detent pins 3A, 3C are moved with the polygonal shaft 51, and the elastic portions 22 are pressed and deformed so as to store elastic force. The detent pins 3B, 3D are pushed to be disposed between the polygon sides of the polygonal shaft 51 and the fastening ring 1 for rolling, therefore no gap is formed. When the output shaft 5 is driven by the driving plate 4 to rotate, the elastic retaining device 2 and each detent pin are simultaneously driven to rotate inside the fastening ring 1. When the motor stops, the output shaft 5 is immediately locked up by the detent pins 3A, 3C through actions of the elastic portions 22, and any collision from a distance, larger than zero, between the detent pins 3A, 3C and the fastening ring 1 due to inertial effect is avoided so no noise is generated.

As shown in FIG. 6B, when the power tool is not supplied with power and the motor is not working, the power tool is used as a manual tool. When a torque is applied on the output shaft 5, the polygonal shaft 51 is immediately locked up. The detent pins 3A-3D are disposed between the polygon sides of the polygonal shaft 51 and the fastening ring 1 through the actions of the elastic portions 22 so no gap is formed, thus the output shaft 5 is immediately locked and not able to rotate. With the aforementioned structure of this invention, the detent pins 3A-3D are disposed between each side of the polygonal shaft 51 of the output shaft 5 and the fastening ring 1 through the elastic actions provided by the elastic portions 22, gap is effectively eliminated and noise is prevented from generating when the output shaft is rotated clockwise or counterclockwise.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A gapless main shaft locking apparatus, comprising:
a fastening ring having a through hole;
an elastic retaining device disposed in the through hole of the fastening ring, the elastic retaining device having an inner space in which elastic portions and cylinder portions are disposed with a manner of being respectively arranged as a pair and aligned at correspondingly symmetrical positions along an axial direction of the inner space;
a plurality of detent pins respectively disposed between one of the elastic portions and one of the cylinder portions in the inner space of the elasticity retaining device;
a driving plate connected to a power system and having a central hole, a periphery of the central hole including a plurality of fan-shaped convex portions, one side of the driving plate having a plurality of concave slot circularly arranged for receiving the elastic retaining device; and
an output shaft including a polygonal shaft that has a cross section shaped in a regular polygon, a number of sides of the polygonal shaft being corresponding to a number of the fan-shaped convex portions, the polygonal shaft passing through the central hole of the driving plate, and each side of the polygonal shaft contacted with one of the detent pins.

2. The locking apparatus as claimed in claim 1, wherein the elastic retaining device comprises a first main body and a second main body symmetric to and connected with the first main body.

3. The locking apparatus as claimed in claim 1, wherein the elastic portions and the cylinder portions are integrally formed with the elastic retaining device and are made of a resilient material.

4. The locking apparatus as claimed in claim 3, wherein the elastic portion is in a V shape.

5. The locking apparatus as claimed in claim 1, wherein a side of the driving plate includes an elevated portion and the concave slots are arranged at a periphery of the elevated portion.

6. The locking apparatus as claimed in claim 1, wherein the cross section of the polygonal shaft is in a square shape, a number of the detent pins is four.
